(19) United States
(12) Patent Application Publication
(10) Pub. No.: US 2013/0307998 A1
(43) Pub. Date: Nov. 21, 2013

(54) INTERACTIVE UNATTENDED PHOTOBOOTH

(71) Applicants: Gerald Monroe Tautenhahn, Newport Beach, CA (US); Carl Henly Tautenhahn, Newport Beach, CA (US); Mark Miller, Huntington Beach, CA (US)

(72) Inventors: Gerald Monroe Tautenhahn, Newport Beach, CA (US); Carl Henly Tautenhahn, Newport Beach, CA (US); Mark Miller, Huntington Beach, CA (US)

(73) Assignee: Third Coast Construction, Inc. dba Photo Booth Options, Costa Mesa, CA (US)

(21) Appl. No.: 13/618,433

(22) Filed: Sep. 14, 2012

Related U.S. Application Data
(63) Continuation-in-part of application No. PCT/US12/38890, filed on May 21, 2012.

(51) Int. Cl. H04N 5/225

(52) U.S. Cl. 348/207.1; 348/E05.024

(57) ABSTRACT

A value management network including photobooths interacting with a master administrative application programming interface (MAAPI), a master database and a master dashboard coupled to the MAAPI, in which the MAAPI retrieves photodata for a customer from a selected photobooth and stores the uniquely identified photodata in a database. The MAAPI collects and stores in the database a file containing a venue identifier, a customer identifier, and the photodata. The master dashboard is configured to manipulate, to create, or to delete the file in the database; and an auxiliary dashboard is coupled to the MAAPI and configured to provide the MAAPI with a data collection element pertaining to the customer. A customer datafile of the customer is provided to the MAAPI by the third-party connection, and combined in the database with the venue identifier, the customer identifier, the token, and the photodata, all accessible in the database by the MAAPI.

### RELATED APPLICATIONS

This application is a continuation-in-part of International Application No. PCT/US12/38890, filed 21 May 2012, which application is hereby incorporated by reference in its entirety.

### BACKGROUND

1. Field of the Invention

The present invention pertains to photographic systems, in general, and photobooth systems, in particular.

2. Background Art

Automatic, coin operated photostudios—or “photographic vending machines”—which are operable by a user for taking self-portraits are well known in the prior art. Generally, these photostudios include a housing that is divided into a studio compartment where the user sits to be photographed and an adjoining apparatus compartment housing a portrait camera and associated film handling and processing equipment. Upon actuating the photostudio, usually by inserting a coin, bill or token into a receiving mechanism or by other means such as actuating an electrical switch, the camera operates to photograph the user sitting in the studio compartment and then the exposed film unit is automatically processed and delivered to the user, via a delivery chute or slot, in a relatively short period of time. Some automatic photostudios use self-developing film units supplied in film holding cassettes and include cassette changing apparatus for moving such cassettes into and out of operative relation with the camera. Generally, such cassette changing apparatus include means for holding a supply of film cassettes and transfer means for moving a cassette from the supply into a camera cassette receiving receptacle, removing the cassette from the receptacle after the film units therein are expended, and replacing the removed empty cassette with a full cassette.

More recently, automatic photostudios may have replaced the film cassettes with a computer printer but the end result is a still bulky product with many custom mechanical elements, making the product expensive to manufacture, expensive to maintain, and difficult to transport, while producing mediocre photographic results.

### SUMMARY

Embodiments herein provide a photobooth network, which is a value management system, including a plurality of photobooths; a master administrative application programming interface (MAAPI) interacting with the plurality of photobooths; a master database coupled to the MAAPI; a master dashboard coupled to the MAAPI. The MAAPI retrieves photodata for a customer from a selected photobooth and stores the photodata in a database, in which the photodata is uniquely identified with the customer for retrieval from the database. The MAAPI collects and stores in the database a file containing a venue identifier, a customer identifier, and the photodata. The master dashboard is configured to manipulate, to create, or to delete the file in the database; and an auxiliary dashboard is coupled to the MAAPI and configured to provide the MAAPI with a data collection element pertaining to the customer. A third-party connection can be configured to provide the MAAPI with a token pertaining to the customer, so that the token and the customer identifier become associated with the customer. A customer datafile of the customer is provided to the MAAPI by the third-party connection and combined in the database with the venue identifier, the customer identifier, the token, and the photodata, wherein the venue identifier, the customer identifier, the photodata, and the customer datafile are accessible in the database by the MAAPI. The photodata is identified by a scannable code imprinted on a photo corresponding to the photodata and the photobooth. The scannable code, when scanned, activates a web page coupled with the MAAPI, wherein the MAAPI provides the data collection element to the web page. The data collection element elicits additional customer data from the customer, and the additional customer data is incorporated into the customer datafile.

In another embodiment, a value management system is provided having a master administrative application programming interface (MAAPI) coupled to a photobooth; a master database coupled to the MAAPI; a first data file stored in the master database representative of a customer of the photobooth; a 3^{rd} party database selectively coupled to the MAAPI; a second data file stored in the 3^{rd} party system database representative of the customer of the 3^{rd} party system; and an auxiliary dashboard selectively coupled to the MAAPI. A selected customer contact causes the MAAPI to match the first data file with the second data file to produce an aggregate customer data file of a customer of the photobooth and the 3^{rd} party system. The MAAPI stores the aggregate customer data file in the master database, the auxiliary dashboard couples to the master database through the MAAPI, and the auxiliary dashboard selectively accesses the aggregate customer data file. An additional embodiment includes an incentive provided to the selected customer based on selected data stored in the aggregate customer data file. In the system, the 3^{rd} party is a social media site, a venue, a vendor, or a sponsor.

### BRIEF DESCRIPTION OF THE DRAWINGS

The invention is generally shown by way of reference to the accompanying drawings, in which:

FIG. 1 is a block diagram of a photobooth system example, in accordance with the teachings of the present invention;

FIG. 2 is an electrical block diagram of the system of FIG. 1, in accordance with the teachings of the present invention;

FIG. 3 is an example screen view of a touch screen, in FIG. 1, prior to phototaking, in accordance with the teachings of the present invention;

FIG. 4 is an representation of a photographic result, or finished photostrip, in accordance with the teachings of the present invention; and

FIG. 5 is a block diagram of a method of phototaking, in accordance with the teachings of the present invention.

Some embodiments are described in detail with reference to the related drawings. Additional embodiments, features and/or advantages will become apparent from the ensuing description or may be learned by practicing the invention. In the figures, which are not drawn to scale, like numerals refer to like features throughout the description. The following description is not to be taken in a limiting sense, but is made merely for the purpose of describing the general principles of the invention.

### DESCRIPTION OF THE EMBODIMENTS

As described herein, the terms “interactive unattended photobooth” and “photobooth system” are synonymous, while “photobooth” can be understood as a portion of the photobooth system.

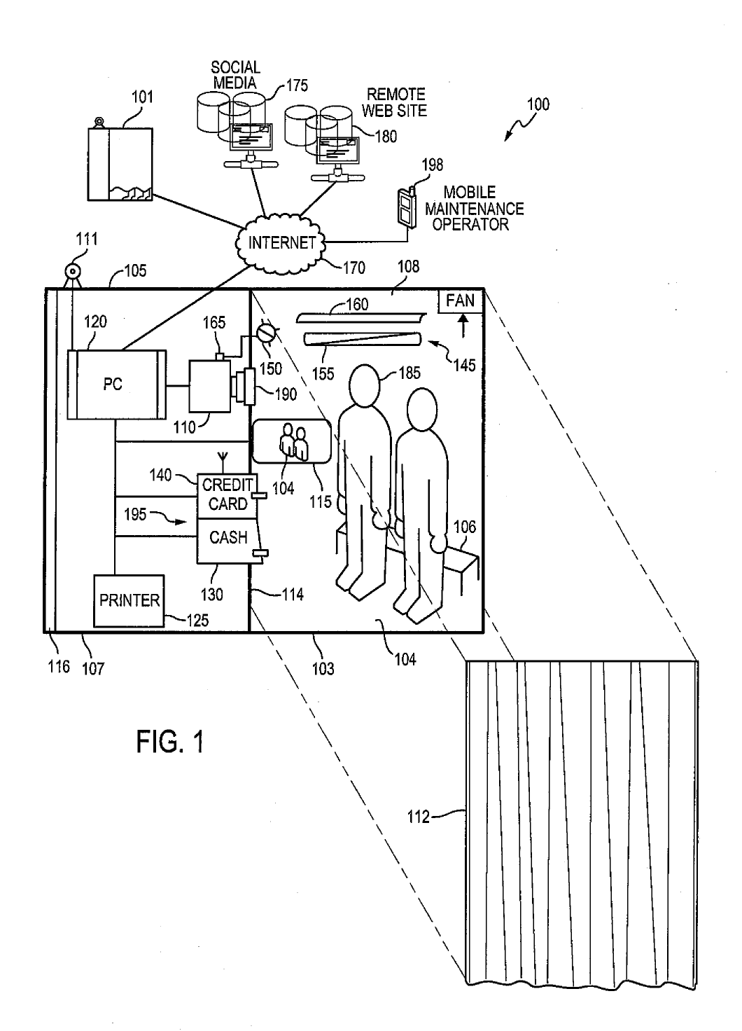

Turning to FIG. 1, photobooth system 100 may include a photobooth cabinet 105, camera 110, touchscreen 115 coupled to camera 110, personal computer (PC) 120 coupled to the camera 110, printer 125, and Internet 177, cash acceptor module 130 and credit card acceptor module 140. Also included is a two-phase lighting system 145 including a photographic strobe light 150 (which may be camera-mounted) and white fluorescent bulb 155 (for example, a 12-in white fluorescent bulb) with a white light reflector 160 thereabove.

Photobooth cabinet 105 may be a six-sided form, generally rectangular parallelepiped, made from lightweight PVC or acrylic sheets, which may be securely fastened together to preserve structural integrity. A single blown or casted cabinet is possible. Other shapes, facades, and materials may be used, if desired, to create a custom or whimsical appearance. Photocabinet 105, although substantial, can be portable. Cabinet 105 may include public section 103, in which the photo subject(s) are posed for a photographic session and working section 107, in which the hardware including at least a portion of one or more of the camera 110, the printer 125, the payment module 195, the touchscreen 115, and the strobe bulb 150, are disposed to facilitate operation and maintenance of system 100. Cabinet 105 may be outfitted with an external webcam 111 and can be configured to be waterproof or watertight relative to the working section 107, or both. Working section 107 typically is secluded from public access by a lockable door 116 or hatch on a front upright side. One side is provided as a floor 104, which may have a bench 106 in the public section 103. Opposing the floor is the ceiling side 108 from which bulb 155 may be strung. The white light reflector 160 is coupled above and in proximity to bulb 155. Bulb 155 and reflector 160 provide a first phase of a two-phase lighting system. At least one upright side (lateral) of photobooth cabinet 105 may have a public opening 114 wide enough to accommodate at least one subject 185 within a preselected field of view of camera 110.

Opening 114 is at least partially covered by a drape or curtain 112. Typically, the drape or curtain 112 may be a dark, obscuring cloth, which covers substantially the entire width and an upper portion of the public opening 114. In some embodiments, the curtain or drape 112 covers the width of the public opening 114 in public section 103, and the upper portion of the public opening from the top of the public opening to no more than 14″ from the floor of the booth, to provide a sense of intimacy to the subject within the booth cabinet 105. In other embodiments, no more than 6″ of vertical exposure from the floor inside of the booth is permitted by the curtain or drape 112. In a case where two public openings 114 are provided in opposite upright sides of the booth cabinet, both openings may be outfitted with the same style of curtain or drape 112, or perhaps, a different type, color, or style may be used.

An upright side at the back of the booth, generally perpendicular to the floor side can serve as a backdrop, although a variety of signs, indicia, trademarks, celebrity images, and whimsical characters may be added to the back upright. In an embodiment, the back upright can be a “green screen” or keyed color which permits photographic substitution of the background. In the upper portion of the photobooth cabinet can be a 12-inch fluorescent bulb, which provides one phase of a two-phase lighting system for the photographic apparatus. The fluorescent bulb 155 provides additional lighting as needed, to enhance the remote live preview 104 of the subject as a preview prior to photography, and to facilitate entry and exit from the photo cabinet 105. The second phase of the photographic lighting system can be provided by a strobe light 150. The strobe light 150 allows a brief brilliant light to illuminate the public cabin 103 synchronized to the exposure time of the photobooth camera 110. Strobe light 150 can be made to flash in response to a trigger. Typically, the trigger is a signal from the hotshoe auxiliary connection for camera 110. However, computer 120 may provide the signal for the trigger. Common fluorescent bulbs providing bright white light output would be among the common stock for fluorescent bulb 155.

The camera 110 used in an exemplary embodiment can be a CANON T1i, T2i, or T3i, having a camera synchronizing hotshoe 132 and continuous phototaking capabilities, remote live preview ability, and the ability to be coupled to the PC 120 with a simple serial connection 172, such as a USB port. The CANON Ti series cameras provide detailed photos of the photo subject due to a high-sensitivity, high-resolution, large single-plate CMOS sensor, which can have up to 18.0 megapixels of resolution. The resulting photographs are crisp, sharp, and, often, of high-end quality for a modest cost. Digital images can be produced that can be used as-is, or can be rendered with digital effects through computer processing of the data stream representing one or more images. The camera 110 can be placed in the working side 107 with a view to a photographic zone in the public side 114 with a predetermined field of view capable of capturing satisfactorily all of the subjects in the photobooth in the vicinity of the backdrop. Remote live preview 104 allows an accurate preview of framing, focusing, and depth of field close to the moment of exposure, because remote live preview 104 is a remotely displayed camera viewfinder image. This allows the photographic subject to pose or posture themselves as they wish—and can see—on the remote live preview 104.

An example personal computer 120 of the exemplary embodiment of system 100 can be an ACER Aspire personal notebook computer, with an Intel Core i7 processor, 4 GB of main memory and 1TB HDD, Model AS5750G by Acer America Corporation, San Jose, Calif., USA. Such a powerful processor and memory combination can receive the camera data stream and allow complex and fanciful photo effects to be rendered upon the photographs after they are taken. Otherwise, a crisp color, or black and white image can be produced. After the photographs are taken and rendered, the images then can be processed by inputting computer 120 photo data stream to printer 125, such as a dye-sublimation printer, providing photos with predetermined effects, acceptable to the consumer, within a reasonably short processing period (on the order of seconds). An example of such a printer can be a Mitsubishi Model CP-9810DW or CP-9550DW.

The strobe 150 typically is connected to the camera 110 by way of a flash synchronization connector (or “hot shoe”) 165. An example of a strobe light used in embodiments can be a JTL S-25M Master AC Slave Strobe, from JTL Corporation, La Mirada, Calif., USA. The PC 120 may be coupled to camera 110 and the Internet 170 and to social media sites 175, allowing exported digital images of the photos obtained by the system to be uploaded to the photo subject's 185 social media account or to a remote database 180.

Prior to the photosession, the photo subject 185 may use the touchscreen 115 to select from offered finished photo choices, which may include a predetermined fanciful effect, and to provide a remote live preview 104 of the photo subject 185 immediately prior to and during the photographic session. By pressing the touchscreen 115 in a region corresponding to a selected photo effect, photo subject 185 expresses an intent for the selected effect. The touchscreen 115 converts this selected effect intent into an effect signal corresponding to the special effect (if any) that the photosubject 185 wishes to have performed on the photosession result by computer 120. The remote live preview 104 is a remote viewfinder image of the camera 110 itself and not a view from a secondary video camera or a mirrored glass. With the live remote preview 104, a subject 185 can see what the camera lens 190 sees without having to peer through the camera viewfinder. The product of a photosession can be a photosession result, which may be one or more digital images.

The PC 120 also can be coupled to a payment module 195 including a bill acceptor device 130, and a stand-alone credit card processor 140 with wireless connection to a remote credit authorization facility. Payment module 195 can be configured to provide electrical pulses via USB port to computer 120 as indicators of payment credits offered, generally one “credit” pulse per credit. A synonym for a credit pulse may be a coin pulse or a value pulse. Typically, the bill acceptor device 130 can be adjusted to provide a pulse of a preselected pulse-width equal to one credit per monetary unit (e.g., 1 unit per $1). Afterwards, stand-alone credit card processor 140 credit pulse pulse-width may be adjusted through a configuration file, or device vendor assistance to match the pulse-width of the credit pulse used to obtain one credit (e.g., a suitable ON pulse-width may be about 100 msec., with about 250 msec. OFF time). The number of credits used for a photographic session may be adjustable, as may the price per credit. For example, if five credits are required to initiate a photographic session, and each credit is representative of one dollar, then the cost of each photographic session can be $5.00. Also, the number of photographs taken and processed during one photographic session may be adjustable, as well. Following in the previous sample, a $5.00 photographic session may yield four (4) photographs. Cash and credit are not the only forms of value collected by the payment module 195. Credits may be obtained by way of, without limitation, tickets, tokens, and non-contact payment cards.

To facilitate stand-alone operation of the photobooth system 100, computer 120 can run control software, including, without limitations, PHOTOBOOF! computer software, San Francisco, Calif. Although the PHOTOBOOF! program currently is not used for unattended operation of photobooth system 100, its source code is available and can be modified and interfaced to custom operational modules to permit stand-alone, unattended operation, cash and credit capturing, operation with remote live preview 104 and touch screen 115, in addition to extant features. For example, a matrix barcode generator, such as a QR code generator, may be incorporated into the control software, which enables the printing of a QR code on each photostrip representative of a preselected URL, such as remote website 180.

Photobooth system 100 is configured for stand-alone operation with remote maintenance or monitoring. Occasionally, photobooth site operators may need to replenish photo paper and other consumable supplies but, in general, the photobooth system 100 is connected through the Internet to a mobile maintenance operator 198, who can collect system 100 information or perform diagnostics, or other maintenance tasks, or invoke report generation. Webcam 111 can be placed externally to cabin 105 and can be used to obtain a view of the general ambience surrounding a portion of the photobooth location. Webcam 111 can transmit “live” images over the Internet to a remote website where viewers remote from the photobooth location can see the ambience of that photobooth site and decide whether the ambience suits their mood (crowded and lively, sparsely populated and hushed, etc.) Webcam 111 can be wireless.

Furthermore, computer 120, webcam 111, or both, also may supply geospatial metadata to other photobooth systems sites, or websites, to form an intelligent network of interactive, unattended photobooth systems 100, 101. While only two interactive, unattended photobooth systems 100, 101 are shown, a network of more than two interactive, unattended photobooth systems 100, 101 is contemplated. This network of interactive, unattended photobooth systems 100, 101 becomes intelligent by online observations, geospatial metadata, or vendor communications exchanged by a plurality of coupled interactive, unattended photobooth systems, but may have little or no information about the overall network state. A interactive, unattended photobooth system 100 may be coupled via the Internet to sponsor websites, value-added websites (collectively, vendors) or other photobooth systems, which may provide incentives to potential patrons currently using a particular photobooth system 100. Each photobooth system 100 in a portion of the network may be coupled to and share geospatial metadata with other photobooth systems 101 in another portion of the network. Websites or photobooth systems 100, 101, or both, may be coupled to the Internet, which exchange, for example, geospatial metadata and which target the photobooth systems 101, 100 for a selected promotion or incentive. For example, a “local” photobooth system 100 may be sited at a lounge in Newport Beach, Calif. and be coupled via the Internet to a “remote” photobooth 101 or website in a Las Vegas, Nev. casino. The remote photobooth system 101, being “aware” of the local photobooth system 100 patron, may push coupon or incentive data to the local photobooth system 100, which coupon or incentive data may be imprinted on or along with the taken photos. The coupon or incentive data also may be pushed to the patron telephone. Patrons of the local lounge then may be desirous of visiting the remote casino, thereby “steering” the patrons to visit the casino as a form of social management. One local photobooth system 100 may communicate with another local photobooth system 100 to promote local events, again performing a “steering” function. The local photobooth system 100 may exchange geospatial metadata, customer preference, demographic information, or other patron characteristics with remote photobooth system 101, with remote website 180, or with both. Remote website 180 may employ a barcode, a two-dimensional barcode (such as a QR code), or a keypad to enroll photo patrons in an incentive program. Remote website 180 may receive incentive information from commercial websites (e.g., nightclub, restaurant, or casino) and, may receive voluntarily provided photo patron identifying characteristics at photobooth system 101 or from social media site 175 or both. Remote website 180 may then push the received incentive information (such as promotional information, discounts, or “free stuff”) to enrolled photo patrons, for example, to their telephones or email accounts. Remote website 180 can create affiliation clusters of networked interactive, unattended photobooth systems 100, 101 at the same site or at different sites. Affiliation clusters of networked interactive, unattended photobooth systems 100, 101, interconnected at points on the Internet, can result in added revenue to the local photobooth system 100 site operator and local photobooth owner alike taking part in a particular affiliation cluster. “Steering” or influencing patrons to visit another location, or to patronize a remote or a local photobooth system 100, or to participate in a selected event can be a loose form of social management effected by the intelligent network, which itself can be seen as a type of commercial enterprise, which may include revenue sharing.

Photobooth system 100 can be used to push corresponding geospatial and other patron data to another photobooth system 101 or to social media sites 175. Photobooth system 100 can be coupled to a social media site 175 including, without limitation, Facebook, MySpace, Flickr, Instagram, and other social media sites, or remote website 180, which may provide or receive user demographic and personal data. Connection to social media site 175 is made via the photobooth user in photobooth system 100. Geospatial data (e.g., physical location) of a photo patron can be received and combined at remote website 180 with corresponding demographic and personal characteristic data of that patron, obtained from the social networking site, to associate that patron's characteristic data with features known about the geospatial and demographic information associated with photobooth system 100. Such association can be used to determine social trends, affiliations, and business associations. Thus, photobooth system 100 is another entry point of a massive data aggregation and analysis system, which may be situated in whole or in part at remote web site 180.

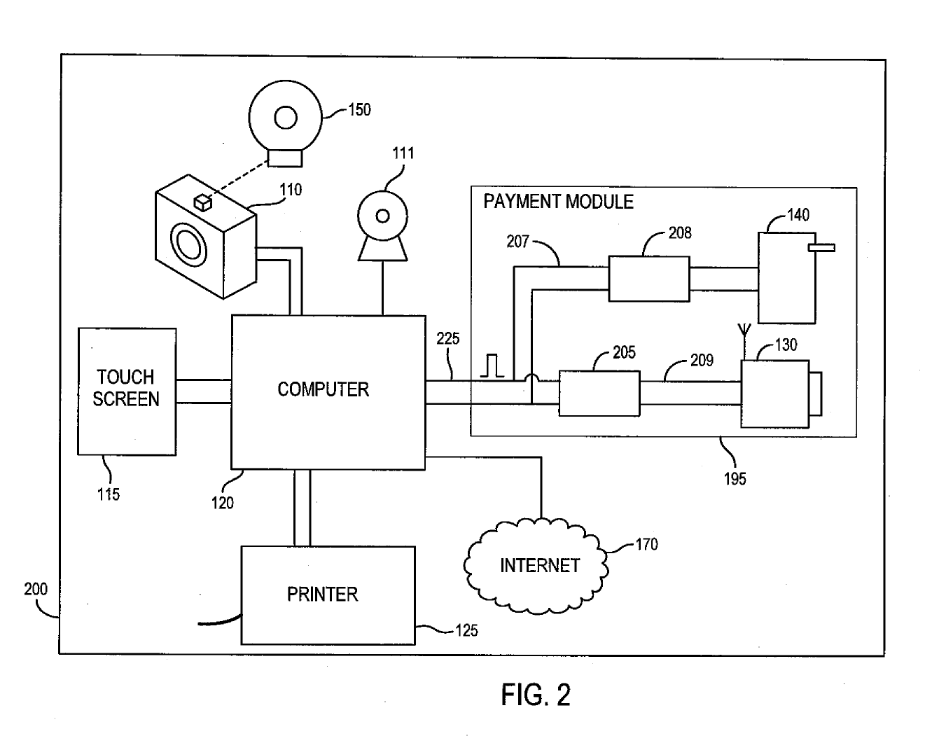

Turning to FIG. 2, electrical connections of the photobooth system 200 can be seen. Photobooth system 200 can have elements similar to elements in photobooth system 100. For example, photobooth system 200 may include camera 110, touchscreen 115, computer 120, printer 125, payment module 190, verification module 193, bill acceptor device 130, credit card processor 140, strobe 150, hot shoe 165 coupled to camera 110, and Internet link 170.

In payment module 195 can be bill acceptor device 130, credit card processor 140, and transaction verification module 205. Bill acceptor device can be configured to output a credit pulse 225 on first coin pulse line 207 for each bill accepted in payment as a single credit. Bill acceptor device 130 is capable of accepting more than one denomination and is configured to output the number of pulses 225 corresponding to the credit corresponding to the denominated bill. For example, a $5.00 bill may cause bill acceptor device to produce five (5) credits. Credit pulses 225 of a predetermined credit pulse-width can be sensed by computer 120 and counted as credits toward a photosession. A non-limiting example of a bill acceptor can be an MEI Model 2611, MEI Corp., West Chester, Pa. USA. Bill acceptor device 130 may not provide signals of a sufficient amplitude or width to conform with credit card processor 140. Therefore, pulse shaping device 208 can be interposed between bill acceptor device 130 and computer 120. Pulse shaping device 208 may be or may not be within payment module 195. However, with input from bill acceptor device 130 pulse shaping device generates a coin pulse with a predetermined credit pulse-width. Credit card processor 140 is configured to accept a credit card for payment. Credit card processor 140 can be a self-contained credit card processor, which is coupled to a cellular phone antenna and is configured to contact a credit authorization company to authorize the transaction. Technical services of a credit card processor 140 vendor may be available to assist with shaping the processor pulse-width output to the predetermined credit pulse-width. A non-limiting example of a credit card processor 140 may be an ePORT EDGE credit card processor from USA TECHNOLOGIES CORP., Malvern, Pa. USA. Transaction verification module 205 can be used to count the total number of transactions, both credit and cash, to more easily permit revenue tracking. Revenue tracking can be used to allocate revenue or value between the photographic system owner, the photographic system site operator, and others who may share in the revenue stream generated by the photobooth.

As with the bill acceptor 130, credit card processor 140 is configured to output on second coin pulse line 209, the adjustable number of pulses corresponding to the credit corresponding to produces credit pulses 225 for the value of a photosession. For example, if a photosession price is $5.00—here, five credit pulses 225—credit card processor processes a transaction for $5.00 and, once authorized, produces, for example, five credit pulses. As with the bill acceptor 130, credit pulses from credit card processor 140 can be sensed by computer 120 and counted as credits toward a photosession. To facilitate merchant transaction accounting, verification module 205 counts the number of credit transactions and the number of credit pulses 225 sent by credit card processor 140. Cash reporting interface 205 can be used to monitor transactions and credits received and to perform cash reporting. A non-limiting example of such a transaction verification module 205 can be an e-PORT EDGE INTERFACE II, from USA TECHNOLOGIES CORP., Malvern, Pa. USA. Computer 120 counts credit pulses 225 and also is programmed to respond to the number of credit pulses 225 needed for a photosession, and the number of photographs taken during a photosession. Credit pulse 225 width and duty cycle can be programmed to meet selected pulse-width ON values (e.g., about 50 to about 200 milliseconds). For example, if a photosession has a value of five credit pulses 225 per four photographs, five credits are received before a photosession is authorized. Once authorized, a total of four photographs could be taken serially by camera 110, in the current example. Touchscreen 115 provides both output and input functions. In one output function, touchscreen 115 makes visible a predetermined “not ready” prompt when at idle. All prompts are hosted in computer 110, for example, in an asset folder. Upon receipt of value and counting of credit pulses for the value of a photosession, the touchscreen may next activate a ready prompt on touchscreen, which is associated with predetermined photographic effects. An example of a touchscreen is a 15″ weather resistant kiosk monitor with infrared touch bezel from IRTouch Systems, LTD., Beijing, P.R. China.

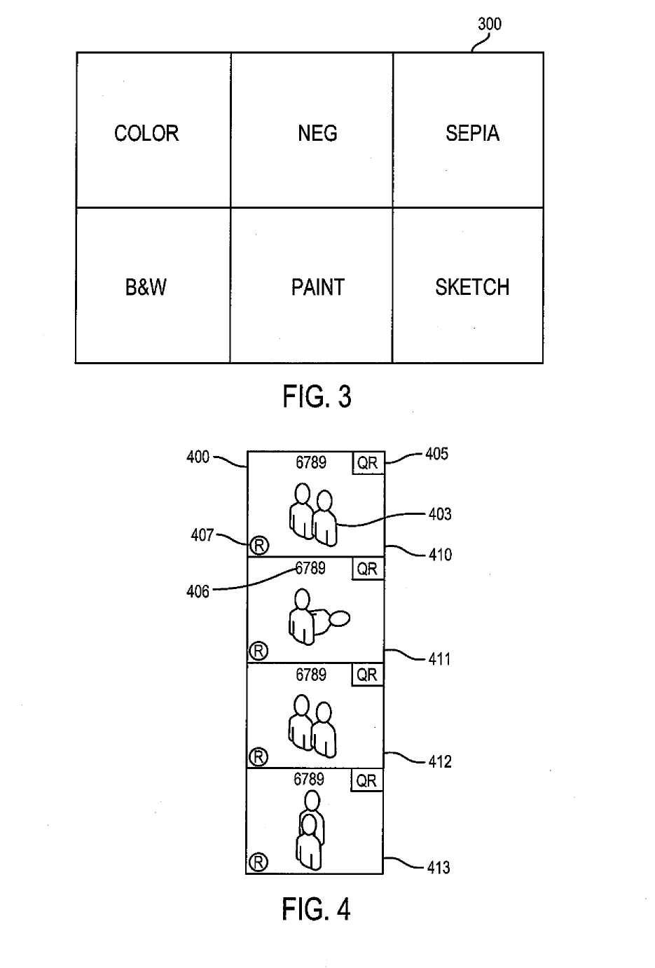

FIG. 3 illustrates that photobooth system 200 can be configured in 3×2 effects matrix. Each effects matrix element corresponds to an active region on touchscreen 115 pertaining to a predetermined effect. The touch screen may be so divided into 2×1, 3>1, 2×2, 3×2, and 4×2 matrices, although other mapping of an effect onto a region of touchscreen 115 may be possible. The photographic subject expresses an intent for a particular effect for the photosession by touching the corresponding touchscreen 115 region. Effects can be, without limitation, color, black-and-white, sepia, negative, sketch, and paint, which are well-known within the digital image arts.

Returning to FIG. 2, touchscreen translates effect intent into an effect signal 210 by touching touchscreen 115 in a predetermined effect area. The effect signal is received by computer 110 and stored until all photographs from a photographic session are taken. Once the photographic subject selects the predetermined effect, touchscreen 115 changes to the remote live preview 104, so that the photographic subject 185 views the actual image, focus, and depth of field detected by camera 110, immediately prior to the initiation of a photo session and operation of the camera 110. Computer 110 is programmed to show remote live preview 185 for a preselected wait period before initiating the photosession, to allow photosubject(s) 185 time to assume desired positions and poses before the camera. Upon the expiration of the preselected wait period, photography begins, and the preselected number of photographs determined for a photosession is repeatedly taken at a preselected interval. Remote live preview 185 remains on touchscreen 115 to show photo subject 185 what the camera is “seeing.”

When a photograph is taken computer 120 sends a photo signal to camera 110, which emits a trigger to flash strobe 150 in synchronized time with the exposure of the camera's internal photographic plate to the photographic subject's image. Alternately, the camera can directly send the trigger to strobe 150. The flash of strobe 150 signals to the subject 185 that a photo was taken.

At the end of the photographic session, after the predetermined number of photos per photographic session, are taken, the photographic result can be processed in computer 110 to render the selected predetermined effect upon the photograph. Once the selected predetermined effect is rendered upon the photographic result, the photographic result is loaded from computer 110 into printer 125. Computer 120 then directs printer 125 to produce a representation of the photographic result, to print the representation purchased by the photographic subject, and to deliver them on a tray 215 abutting a slot in the working side.

FIG. 4 provides an example depiction of a representation of the photographic result, generally at 400, which includes a strip of photographs each rendered with the selected predetermined photographic effect. Images of photographic subjects 403 can be seen on the result, with the number of consecutive “shots” 410, 411, 412, 413 corresponding to the established number of photographs per photosession. On the representation 400 can be a unique indicium 405, as well as one or more identification 406 (e.g., database identifier) or affiliation 407 indicia, (e.g., one or more trademark or logo). The unique indicium can be a matrix barcode (such as a QR code), corresponding to the website of the photobooth system 100 vendor (not shown). The indicia may appear once on the representation 400 or may appear on each “shot” 411-413.

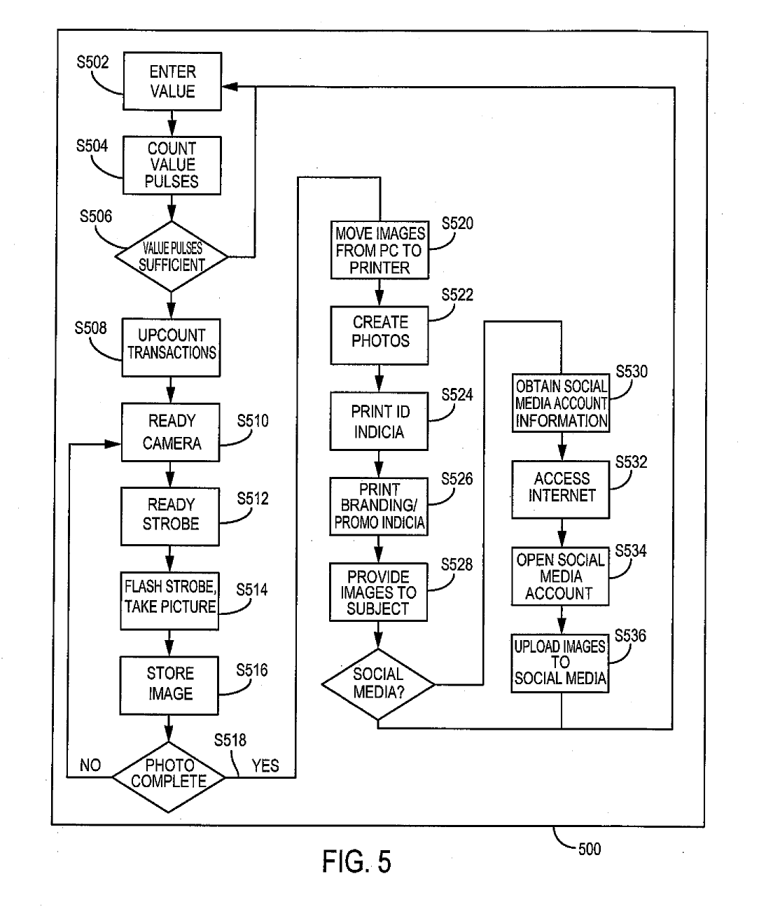

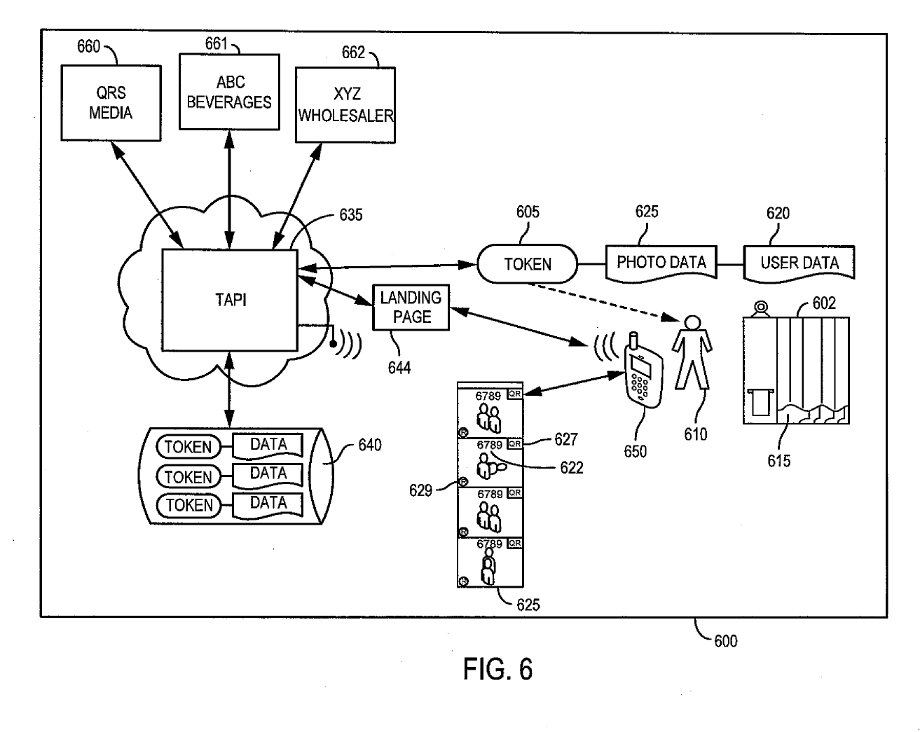

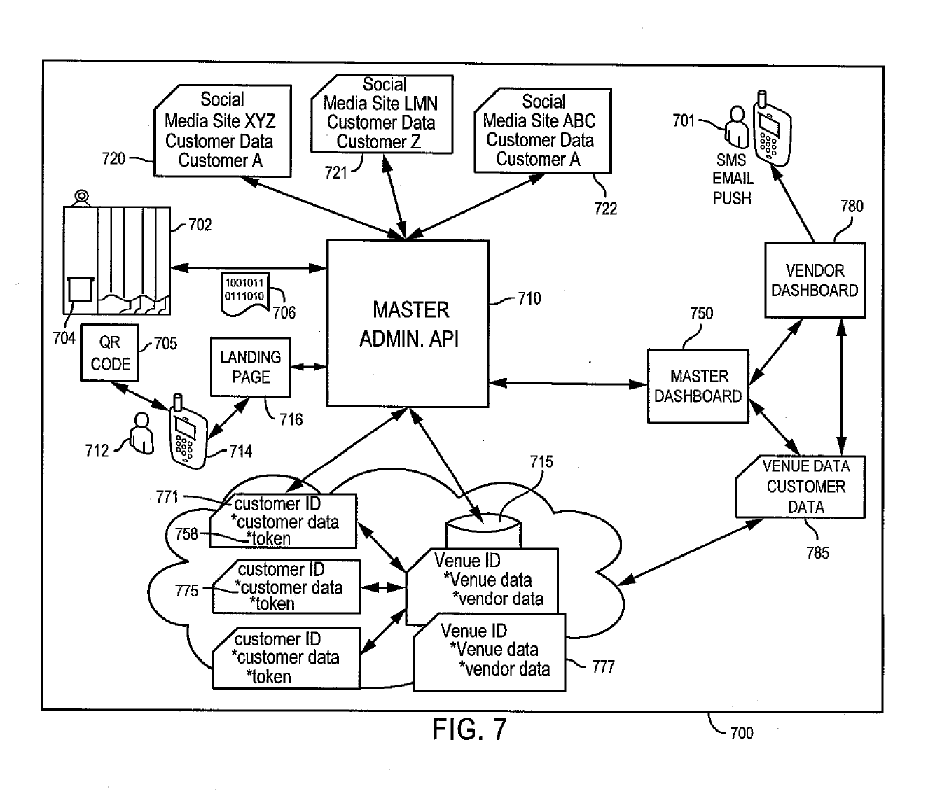

FIG. 5 illustrates a non-limiting example of a method 500 for using a photobooth system as described in FIGS. 1-4. Method 500 begins by a subject entering (S502) value into a payment module to produce a credit pulse and counting (S504) credit pulses to verify (S506) that a sufficient value has been received as indicated by the number of credit pulses counted (S504). If sufficient credit pulses have not accrued, more value can be entered (S502). If sufficient credit pulses have accrued, the method continues by upcounting (S508) the number of transactions performed for value, readying (S510) the camera, and readying (S512) the strobe for flashing. Readying of the strobe and camera allows a counting down of a predetermined length in preparation for flashing the strobe and taking the photo of the subject (S514), and storing (S516) the photo image for future processing.

After the predetermined number of photographs are taken during a transaction (S518), then processing (S520) the images for the effects selected by the subject. With any photo effects completed, the method may continue by creating (S522) the photos in a printer and imprinting (S524) unique indicia, for example, a matrix barcode such as a QR code, and imprinting (S526) other indicia, including promoting and sponsorship indicia, onto the photographic images. Once printing has completed, providing (S528) the images to the photographic subject is effected. In the case where the photographic subject wishes the images from the photographic session to be shared on social media, the method continues by obtaining (S530) the social media account information of the photographic subject, accessing (S532) the Internet, opening (S534) the social media account, and uploading (S536) the digital version of the photographic images, which may include the aforementioned indicia. Instead of a social media account, the account could be a subject folder on a remote website.

An embodiment of a method of doing business can include utilizing an interactive unattended photobooth system to route a digital photo identified by a unique indicium to a social medium website account while allocating value received for the digital photo between an interactive unattended photobooth system site operator and an interactive unattended photobooth system owner. The unique indicium may be a barcode, two-dimensional barcode, logo, or trademark. The indicium may be on the front side of the photographic paper, the back side, or both. In one aspect of the embodiment, the interactive unattended photobooth system may be provided to the interactive unattended photobooth system site operator by the interactive unattended photobooth system owner at a low or no cost to the site owner, in exchange for a percentage of photobooth system earnings being paid to the site owner by the photobooth system owner or lessor. Tracking the number of credits for each photo session is one way by which the percentage of photobooth system earnings may be allocated thereto. Imprinting a photobooth system owner of lessor symbol, trademark, or logo on the reverse side of the paper further may add value. Imprinting a sponsorship indicium also may be representative of obtaining additional value for the photo, or the photobooth system. Also, imprinting a logo of the site owner may be useful to provide site branding and as a record of an enjoyable time at the photobooth system site location.

The foregoing examples and embodiments can further be illustrated by additional examples and embodiments. In certain other embodiments, such as those broadly illustrated in FIG. 6, photobooth 602 is an entry point into a value management system 600, in which a plurality of user-related tokens and data are collected, managed, and exchanged. Data can be yielded as a result of the aforemention “steering” function, in which patrons (such as photobooth user 610) are steered into accepting promotions of the several venues (661), vendors (662), or sponsors (663), or into physically becoming customers of one or more of the several venues, vendors, or sponsors. The steered party can provide to a social media site, venues, vendors, or sponsors data about their preferences and demographics. A social media site can be a website for a company providing social media services, such as Facebook®, Twitter®, LinkedIn®, Google+®, or the like. A venue can be the scene or locale of any action or event, in this case, a selected photobooth 702 at a selected location. A vendor can be a 3^{rd} party who sells or delivers goods or services to a customer. A sponsor can be a 3^{rd} party who provides financing in exchange for advertisement or a good or service. Accepting a promotion or becoming an actual customer can be accompanied by a voluntary provision of data by user 610, in the aggregate, creating a large pool of customer data. The customer data corresponding to a particular customer (e.g., user 610), may be uniquely tagged by a token, a customer ID, or some identifier or attribute that corresponds the customer data to the customer in some way.

For example, token 605, uniquely corresponding to a photobooth user 610, may be allocated during a photosession 615. The series of photographs 625 obtained during a photosession 615 can be a first form of data, in print, in digital form, or both. User 610 can voluntarily provide information (user data 620) in the course of obtaining a photograph series 625, which provided information 620 is a second form of data coupled by token 605 to user 610. Each photosession 615 also can be assigned a unique photosession number 622 corresponding to a predetermined photograph series 625 and associated with token 605, assisting retrieval of the photo series 625 of photosession 615 from storage. Each photo series 625 includes a unique indicium 645, such as a QR code, or a two-dimensional barcode, which provides, without limitation, unique customer identification, venue identification and/or data, event data, and a custom URL link. Additionally, each photo within a photosession photo series 625 may be assigned a photo identifier 630, which can correspond to the photo's position in the photosession series. Moreover, one or more branding marks (e.g., sponsor trademark) 629 may be imprinted as an value-added element of the value management system 600. Use of sponsorships may be an additional way by which management system 600 may be monetized. A sponsor may be given selected access to database 640 in order to identify actual or likely customers, their preferences, and their demographics.

Token 605 may be associated with a plurality of photosession photo series 615, which token 605 can uniquely correspond to user 610, who possesses the photo strip corresponding to each photo series 615. Token 605 can be associated with information 620, 625 uniquely regarding user 610, which token 605 and associated information 620, 625 can be stored by a Token Application Programming Interface (TAPI) 635, with TAPI 635 warehousing the token 605 and the associated data 620, 625 in database 640 for future consumption at least in part by, for example, user 610, a venue 660, a vendor 661, or a sponsor 662 (together, venue or venues 660). TAPI 635 also receives status updates from one or more photo booths with which it interacts, and is able to reset a photobooth as indicated. Moreover, TAPI 635 can receive notification and identification of photobooth and network faults, as well as diagnostic information regarding the faults, allowing for timely repairs of malfunctioning elements of system 600.

User 610 may retrieve photos, review, add to, or change user information, or answer questions posed when visiting the photograph database site. Information 620 associated with user 610 (the second form of data) and, therefore, with token 605, can include demographic information, including without limitation, age, gender, home location, current location, user income level, user preferences, proclivities, and predilections regarding food, beverages, consumables, clothing, housing, vehicles, events, lifestyle, prior life history, expressed desires, and any quantifiable datum pertaining to that user. Token 605 may be provided by photobooth 602, or may be provided by any one of venue 660, vendor 661, or sponsor 662. In some embodiments, token 605, information 620, or both can be provided by a social media website, here represented by media 660.

It is to be understood that the photobooth 602 is an example of a front end or data entry point for allocating tokens for, and for collecting information into, value management system 600. By way of system 600, a venue 660 (or vendor 661, or sponsor 662) may be provided intelligence regarding their actual customer base, providing focused marketing, advertising, and promotions for participating venues 660. A two-dimensional bar code 645, “QR” code, or other encoded, unique indicium can be used to gain entry into system 600. For simplicity, code 645 is represented by QR code 645. Computer 110 an FIG. 1) can encrypt into the QR code 645, a venue ID, a customer ID, a photosession ID, or a custom URL or other data pertaining to the photosession event producing the photo series 625, up to the information capacity of QR code 645. User 610 can be provided with a QR code 645 as a unique indicium on the printed version of photo series 625, with the corresponding data being stored as elements of user data 620.

By scanning QR code 645 with a smart phone 650, user 610 can be taken to a custom landing page 644 or custom URL, as provided by the venue 660. If venue 660 is a photobooth 602 of system 600, then user 610 will be able to view, manipulate, upload, or download the digital images represented by the QR code 645 and session ID 622. Other links may be made available on custom landing page 644, including those to a social media site, a venue, a vendor, or a sponsor. Connection to a social media site (represented by file 660) is made via user 610 (here, also representing photobooth customer A), which site 660 provides TAR 635 with customer datafile 620 corresponding to Customer A. The custom URL provided by QR code 645 can direct a user's mobile device 650 to a custom landing page 644. The custom landing page 644 may direct user 610 to venue 660, vendor 661, or sponsor 662. For example, user 610 may be able to upload to a media site (here, represented by venue 660), digital images representative of photosession 620 for web-based viewing. The custom landing page 644 also may be used to collect additional preference or demographic data for venue 660, vendor 661, or sponsor 662. The custom landing page 644 also may collect additional information from user 610, which can be incorporated with other information associated with token 605. By token 605, user 610 can become associated with the data in the QR code 645 which also is collected and saved as user data 620 in database 640. At the landing page 644, user 610 may then be asked a series of questions pertaining to lifestyle, preferences, or other data of interest to a venue 660, a vendor 661, or a sponsor 662. The responses to these questions also may be stored as user data 620. Over time, the richness of the dataset in database 640 allows an authorized venue 660, vendor 661, or sponsor 662 to drill down into relevant demographic data about the actual customers, for example, who attend their events, or who use their products. Venue 660, vendor 661, and sponsor 662 may be provided with interfaces through TAPI 635 into database 640, allowing customer identification and targeted marketing.

FIG. 7 depicts yet another embodiment of a value management system 700, which may incorporate a photobooth 702, as a user entry point. System 700 can be similar, but not identical to, system 600. The photograph strip 704 taken in photobooth 702 can have a custom URL or QR code 705 imprinted on photograph strip 704. Code 705 can be generated by a computer (not shown) within the photobooth 702 along with printing of photograph strip 704. The computer in the photobooth 702 generates a QR code 705, printed strip 704, and a digital data file 706 representative of the images on photograph strip 704. Photobooth 702 can be in communication with a web-based Master Administrative API (MAAPI) 710, which collects, synchronizes and stores the images in files on cloud-based database 715. A QR code 705 can be imprinted onto photograph strip 704. The data embedded in QR code 705 may include customer ID, venue ID, and photosession number unique to the photosession during which photograph strip 704 was generated. This session data along with the digital image data generated during the photosession may be managed by MAAPI 710 and stored, for example, in files indexed by venue ID in database 715. MAAPI 710 also receives status updates from one or more photo booths with which it interacts, and is able to reset a photobooth as indicated. Moreover, MAAPI 710 can receive notification and identification of photobooth and network faults, as well as diagnostic information regarding the faults, allowing for timely repairs of malfunctioning elements of system 700.

When user 712 wishes to view the stored digital image data, user 712 may access the data by scanning QR code 705 with user smart phone 714. An application within user smart phone 714 can decode QR code 705, causing a web landing page 716 to be displayed on user smart phone 714. Web landing page 716 can be associated with the venue of photobooth 702, and can display directions for user 712 to access stored digital image data (photodata) 706, i.e., to view the photos of user 712 taken during a selected photosession. Because the scanned QR code 705 includes data on customer ID, venue ID, and a unique photosession number, the associated photodata can be retrieved from database 715 by MAAPI 710 and delivered to user smart phone 714. While on the mobile landing page 716, user 712 may be asked several questions about their demographics or preferences, the answers to which are stored by MAAPI 710 into a customer data file 770, associated with the customer ID 771. The mobile landing page may include links to other venues, vendors, or sponsors that provide goods, services, or promotional materials in exchange for additional voluntarily offered customer data. Geospatial data provided by smart phone 714 may permit local venues, vendors, or sponsors to contact user 712 about local events or promotions.

In an instance in which user 712 wishes to upload the photodata 706 to a social media site, user 712 may be asked for log in data and, once authenticated, user 712 is assisted by MAAPI 710 in uploading photodata 706 to the selected social media site (represented by files 722, 723, 724) using, for example, an open-specification social media site API. During the uploading, the social media site, e.g. social media site XYZ 722, can transmit token 750 to MAAPI 710 and accumulated data from user 712, known to site 722 as “Customer A” 701. Customer A 701 user data 770 and the social media site 722 token 750 can become associated with the unique identifier of the photosession, venue, and customer ID 771 in MAAPI 710, and stored as customer data 775 in the venue-indexed files of database 715, according to the venue of the photosession (here, photobooth 702). Therefore, a customer data file 770, for example user 712 (which may be Customer “A” 701) can be associated with venue ID, venue customer number, venue-collected photodata 706 and user data (native data), in addition to any customer A data provided by social media site 722 (inherited data), including site token 750. In all, the photodata, venue data, native and 3^{rd} party data associated with any customer can be called an aggregate file. Upon reaching a landing page 716, a venue may ask questions associated with a selected venue, vendor or sponsor. The answers to these questions may also become native data pertaining to the selected vendor. During the visit of user 712 to web landing page 716, venue and vendor data such as logos, images, visual branding data and other custom URLs may be retrieved from the venue file folder by MAAPI 710 and pushed to user smart phone 714 for display while on page 716. In general, then, the aggregate files of database 715 can be arranged by venue ID, with each venue-related file containing venue data, vendor data, and customer data sub-files. A customer-related subfile can contain customer ID from the photosession, a token from a 3^{rd} party site, such as a social media site, and a collection of customer data, pertaining to user 712 (who may be Customer A 701). Customer data 770 can include inherited data, for example, from the social media site 722, and native data including photodata 706, and information 775 collected by the venue without intervention by 3^{rd} party sites. Vendor sub-files 777 can contain vendor-related logos images and questions, for each selected vendor cooperating with a venue. These logos, images, and questions may be pushed to user 712 via smart device 714. Vendor data also may be sponsor data.

In addition, MAAPI 710, and hence system 700, may be controlled by the supervisory user interface master dashboard 750. Master dashboard 750 is a cloud-based SaaS (Software as a Service) application that interfaces to MAPI 710 and allows supervisory personnel to manage database 710, create files, create auxiliary dashboards (interfaces), and manage venue, vendor, or customer data. Also, master dashboard 750 can be used to couple to, to add, or to remove 3^{rd} party media site, a venue, a vendor, or a sponsor (e.g., 721-723). Dashboard 750 also can be used to add or to remove venues (e.g., 702) to add or to remove sponsor data, vendor data, or venue data, to add or to remove auxiliary interfaces (e.g., 780) to MAAPI 710, or to manage operational or administrative functions within system 700.

Auxiliary dashboard (“vendor” dashboard) 780 can be provisioned by supervisory personnel to any vendor, venue, or sponsor that wishes to view demographic information about their actual customers which has been collected by system 700, and which may be live demographic information. Auxiliary dashboard 780 allows a venue, a vendor, or a sponsor to view, to filter and to perform analytic analysis of the customer data for their customers as maintained in database 715. Auxiliary dashboard 780 also can allow a vendor to add, to remove, or to change questions pertaining thereto, further customizing the data that is collected on their behalf.

Using auxiliary dashboard 780, a vendor or other 3^{rd} party is able to select customers (e.g., Customer A 701) for direct contact via smart phone, including SMS, email, or texting. The 3^{rd} party can be a social media site, venue, vendor, or sponsor that wants to disseminate targeted information, promotional materials, premiums (or hyperlinks) about, without limitation, venues, events, contests, sports, gatherings, promotions, products, or personalities. This is but one of a myriad of ways in which Customer A can be further “steered” to any 3^{rd} party participating in value management system 700. In one example, Customer A 701 may be chosen to receive an incentive based on selected data stored in the aggregate customer data file.

Although the present invention has been described in terms of example embodiments, it is to be understood that neither the Specification nor the Drawings are to be interpreted as limiting. Various alternations and modifications are inherent, or will become apparent to those skilled in the art after reading the foregoing disclosure. It is intended that the appended claims be interpreted as covering all alternations and modifications that are encompassed by the spirit and the scope of the invention. Therefore, unless such changes and modifications depart from the scope of the present invention, they should be construed as being included therein.

1. A photobooth network, comprising:
a plurality of photobooths;
a master administrative application programming interface (MAAPI) interacting with the plurality of photobooths;
a master database coupled to the MAAPI;
a master dashboard coupled to the MAAPI;
wherein the MAAPI retrieves photodata for a customer from a selected photobooth and stores the photodata in a database;
wherein the photodata is uniquely identified with the customer for retrieval from the database;
wherein the MAAPI collects and stores in the database a file containing a venue identifier, a customer identifier, and the photodata;
wherein the master dashboard is configured to manipulate, to create, or to delete the file in the database; and
an auxiliary dashboard coupled to the MAAPI and configured to provide the MAAPI with a data collection element pertaining to the customer.

2. The photobooth network of claim 1, further comprising:
a third-party connection configured to provide the MAAPI a token pertaining to the customer wherein the token and the customer identifier become associated with the customer.

3. The photobooth network of claim 2, further comprising a customer datafile of the customer provided to the MAAPI by the third-party connection and combined in the database with the venue identifier, the customer identifier, the token, and the photodata, wherein the venue identifier, the customer identifier, the photodata, and the customer datafile are accessible in the database by the MAAPI.

4. The photobooth network of claim 3, wherein the photodata is identified by a scannable code imprinted on a photo corresponding to the photodata and the photobooth.

5. The photobooth network of claim 4, wherein the scannable code, when scanned, activates a web page coupled with the MAAPI, wherein the MAAPI provides the data collection element to the web page.

6. The photobooth network of claim 5, wherein the data collection element elicits additional customer data from the customer, and wherein the additional customer data is incorporated into the customer datafile.

7. A value management system, comprising:
a master administrative application programming interface (MAAPI) coupled to a photobooth;
a master database coupled to the MAAPI;
a first data file stored in the master database representative of a customer of the photobooth;
a 3^{rd} party database selectively coupled to the MAAPI;
a second data file stored in the 3^{rd} party system database representative of the customer of the 3^{rd} party system;
an auxiliary dashboard selectively coupled to the MAAPI;
wherein a selected customer contact causes the MAAPI to match the first data file with the second data file to produce an aggregate customer data file of a customer of the photobooth and the 3^{rd} party system,
wherein the MAAPI stores the aggregate customer data file in the master database,
wherein the auxiliary dashboard couples to the master database through the MAAPI, and
wherein the auxiliary dashboard selectively accesses the aggregate customer data file.

8. The value management system of claim 7, further comprising an incentive provided to the selected customer based on selected data stored in the aggregate customer data file.

9. The value management system of claim 8, wherein the 3^{rd} party is a social media site, a venue, a vendor, or a sponsor.
